(19) United States
(12) Patent Application Publication
(10) Pub. No.: US 2005/0276746 A1
(43) Pub. Date: Dec. 15, 2005

(54) Catalytic reactor for hydrogen generation systems

(76) Inventors: Qinglin Zhang, Manalpan, NJ (US); Gregory M. Smith, Marlboro, NJ (US); Zongxuan Hong, Houston, TX (US)

Correspondence Address: DICKSTEIN SHAPIRO MORIN & OSHINSKY LLP, 2101 L Street, NW, Washington, DC, 20037, US

(21) Appl. No.: 10/867,032

(22) Filed: Jun. 14, 2004

(51) Int. Cl. C01B 3/02

(52) U.S. Cl. 423/651; 422/146

(57) ABSTRACT

The operating characteristics of catalytic reactors used in systems which generate hydrogen from the contact of a fuel with a catalyst are enhanced by such reactors incorporating one or more of group of elements consisting of (a) a heat exchanging element that preheats the fuel solution prior to its contact with the catalyst, (b) one or more liquid diffusing elements which distributes the flow of fuel over the catalyst so as to increase the generation hydrogen from such contact, (c) multiple catalysts having different hydrogen generating characteristics and d) a membrane capable of operating at pressures equal to or greater than 50 psig which surrounds catalytic material in the reactor and separates the generated hydrogen from the fuel.

### FIELD OF THE INVENTION

The present invention relates to the design of a catalytic reactor used in a system for generating hydrogen from a fuel solution, such generation being promoted by contact of the fuel solution with catalytic material in the reactor.

### BACKGROUND OF THE INVENTION

Hydrogen is the fuel of choice for fuel cells, however, its widespread use is complicated by the difficulties in storing the gas. Many hydrogen carriers, including hydrocarbons, metal hydrides, and chemical hydrides are being considered as hydrogen storage and supply systems. In each case, specific systems need to be developed in order to release the hydrogen from its carrier, either by reformation as in the case of hydrocarbons, desorption from metal hydrides, or catalyzed hydrolysis of chemical hydrides.

One of the more promising systems for hydrogen storage and generation utilizes borohydride compounds as the hydrogen storage media. Sodium borohydride (NaBH₄) is of particular interest because it can be dissolved in alkaline water solutions with virtually no reaction; in this case, the stabilized alkaline solution of sodium borohydride is referred to as fuel. Furthermore, the aqueous borohydride fuel solutions are non-volatile and will not burn. This imparts handling and transport ease both in the bulk sense and within the hydrogen generator itself.

Various hydrogen generation systems have been developed for the production of hydrogen gas from aqueous sodium borohydride fuel solutions. Such generators typically require at least three chambers, one each to store fuel and borate product, and a third chamber containing a catalyst to promote hydrolysis of the borohydride. Hydrogen generation systems can also incorporate additional components such as hydrogen ballast tanks, heat exchangers, condensers, gas-liquid separators, filters, and pumps.

The current technology for hydrogen generation from stabilized sodium borohydride solutions involves feeding the fuel solution at ambient temperature to a catalyst bed packed with a catalyst to promote hydrogen generation. The hydrogen gas and discharged fuel solution pass to a second chamber which acts as both a gas/liquid separator and as a small ballast tank to store hydrogen gas. The hydrogen gas can next be processed through heat exchangers to achieve a specified dew point, condenser elements to remove water from the gas stream, and filters to remove entrained mist before the gas is fed to fuel cell or internal combustion engine.

In order to deliver the necessary rapid hydrogen generation response required for the effective operation of a fuel cell, large volume catalytic reactors are typically required. Such large volume reactors obviously require corresponding quantities of catalyst. As the most reactive catalyst metals are the relatively expensive Group VIII metals such as platinum, palladium, and ruthenium, the catalyst is a major contributor to the cost of a hydrogen generating system.

In addition, these large reactors demonstrate significant fuel hold-up of about 80% of reactor volume. When the demand of the fuel cell rapidly changes from high H₂ flow rates to low or zero H₂ flow rates, a considerable amount of fuel remains in the reactor. Any hydrogen generated by this residual fuel that is not immediately needed by the fuel cell must be vented from the reactor chamber as it cannot remain in the chamber without posing a potential safety risk.

It is desirable to develop catalytic reactor technology for hydrogen generation that reduces the reactor volume and cost without sacrificing the fast dynamic system control, high fuel conversion and high reactor throughput (the amount of hydrogen generated per unit time and per unit reactor volume) of the larger reactors. High reactor throughput is necessary to reduce the overall size of hydrogen generation systems and improve control under cyclic or frequent load changing conditions. Reactor technology that contributes to minimal balance of plant while maximizing fuel concentration and conversion is essential to maximize overall hydrogen storage density.

Attempts to develop improved reactor technology for hydrogen generation from metal hydride fuels have not yet addressed all of these issues. For example, an integrated reactor is described in U.S. Patent Application Publications 2003/0194368 A1 and 2003/0194369 A1. This reactor includes membrane fabricated from polytetrafluorine ethylene or polyethylene/polypropylene composite material, such as those commercially available under the Gore-Tex® and Celgard® trade names, for separating the hydrogen generated from the liquid fuel wherein the membrane is disposed around a catalyst bed having a plated screen or baffled (divided) catalyst bed. Such reactors are intended for operation at low temperature conditions with an upper limit of between about 80 and 100° C. and pressure conditions below 50 psig. The loosely packed or baffled catalyst beds of those systems lead to considerable back mixing and channel leak that contribute to low fuel conversion and low reactor throughput. In contrast, practical hydrogen generation systems using chemical hydride fuels typically operate at elevated temperatures above 100° C. and pressures exceeding 50 psig as described in detail in “Water and heat balance in a fuel cell vehicle with a sodium borohydride hydrogen fuel processor,” Proceedings of Future Transportation Technology Conference, June 2003, Costa Mesa, (2003-01-2271).

### SUMMARY OF THE INVENTION

Broadly, the present invention improves the operational performance of catalytic reactors and the hydrogen generating systems in which such reactors are disposed by incorporating one or more performance enhancing elements in the reactor. These elements include:
a) a heat exchanging element that preheats the fuel solution prior to its contact with the catalytic material in the reactor,
b) one or more liquid diffusing elements which distributes the flow of fuel over the catalytic material,
c) different catalytic materials within a reactor, each material having hydrogen generating capabilities that are different from those of the other materials, and
d) a membrane capable of operating at pressures of at least 50 psig (gauge pressure in pounds/inch²) which surrounds catalytic material in the reactor and separates hydrogen from the fuel solution.

As described hereinbelow, the use of a heat exchanging element to preheat the fuel solution enhances the rate of reaction between the fuel and the catalyst. The use of one or more fuel diffusing elements within the reactor enhances the contact of the fuel solution with the catalyst so as to increase the rate of hydrogen generation. The use of two or more different catalytic materials having different hydrogen generating capabilities within the reactor can enhance certain operational characteristics of the reactor, e.g., start-up response time. The use of a membrane capable of withstanding pressures of at least 50 psig enhances the operation of the reactor by providing separation of the generated hydrogen from the liquid fuel within the catalytic reactor, eliminating or reducing the size of downstream gas/liquid separation elements, while also providing the higher hydrogen generation rates attainable at such pressures. Each of the foregoing elements can be used singularly or in any combination, as desired, and the present invention is compatible with use in otherwise conventional hydrogen generation systems, including such systems which recycle the water output of the fuel cell to which the hydrogen is delivered. Such recycling of the water advantageously utilizes what is normally considered a waste product of fuel cell operation dilute highly concentrated fuel solutions that are stored. The storage of highly concentrated fuels reduces the size of the required fuel storage tank in a given application.

### BRIEF DESCRIPTION OF THE DRAWINGS

A complete understanding of the present invention may be obtained by reference to the accompanying drawings when considered in conjunction with the following detailed description, in which:

FIG. 1 is a schematic of a typical hydrogen generation system.

FIG. 2 is a cut-away view of a catalyst reactor integrated with a heat exchange coil surrounding a packed catalyst bed in accordance with one aspect of the present invention.

FIG. 3 is a cut-away view of liquid distributors attached to the inner wall of the reactor chamber in accordance with another aspect of the present invention.

FIG. 4 is a cut-away view of a catalyst reactor with liquid distributor and jacketed heat exchanger surrounding the catalyst bed in accordance with still another aspect of the present invention.

FIG. 5 is a cut-away view of an integrated reactor containing two-catalysts, a liquid distributor and central heat-exchange fuel inlet tube in accordance with yet another aspect of the present invention.

FIG. 6 is a cut-away representation of a catalytic reactor incorporating liquid distribution, heat exchange, and membrane elements in accordance yet still another aspect of the present invention.

FIG. 7 is a schematic of a hydrogen generation system incorporating an illustrative embodiment of a catalytic reactor in accordance with the present invention.

### DESCRIPTION OF THE INVENTION

The chemical hydride fuel component useful in an exemplary hydrogen generation system employing a catalytic reactor is a complex metal hydride that is water soluble and stable in aqueous solution. Examples of suitable chemical hydrides are those borohydrides having the general formula MBH₄, where M is an alkali or alkaline earth metal selected from Group 1 or Group 2 of the periodic table, such as sodium, potassium, and calcium. Examples of such compounds include without intended limitation NaBH₄, KBH₄, and Ca(BH₄)₂. These metal hydrides may be utilized in mixtures, but are preferably utilized individually. Preferred for such systems in accordance with the present invention is NaBH₄.

Borohydrides react with water to produce hydrogen gas and a borate in accordance with the following chemical reaction:
MBH₄+2H₂O→MBO₂+4H₂+300 kJ Eqn. 1

Sodium borohydride is preferred in the present invention due to its comparatively high solubility in water, about 35% by weight as compared to about 19% by weight for potassium borohydride. Two molecules of water are consumed for each borohydride molecule during the reaction illustrated above, and a saturated 35 wt-% sodium borohydride solution contains a stoichiometric excess of water. In other words, sufficient water is present in the solution to allow for complete conversion of the sodium borohydride. Typically, the fuel solution is comprised of from about 10% to 35% by wt. sodium borohydride and from about 0.01 to 5% by weight sodium hydroxide as a stabilizer.

For sodium borohydride, this reaction shown in Eqn 1 occurs very slowly in the absence of a catalyst at alkaline pH, such as when a hydroxide base is added to the fuel solution. Effective borohydride conversion to hydrogen depends on the activity of the catalyst, and also is influenced by the hydrodynamic and pressure conditions of the catalytic reactor.

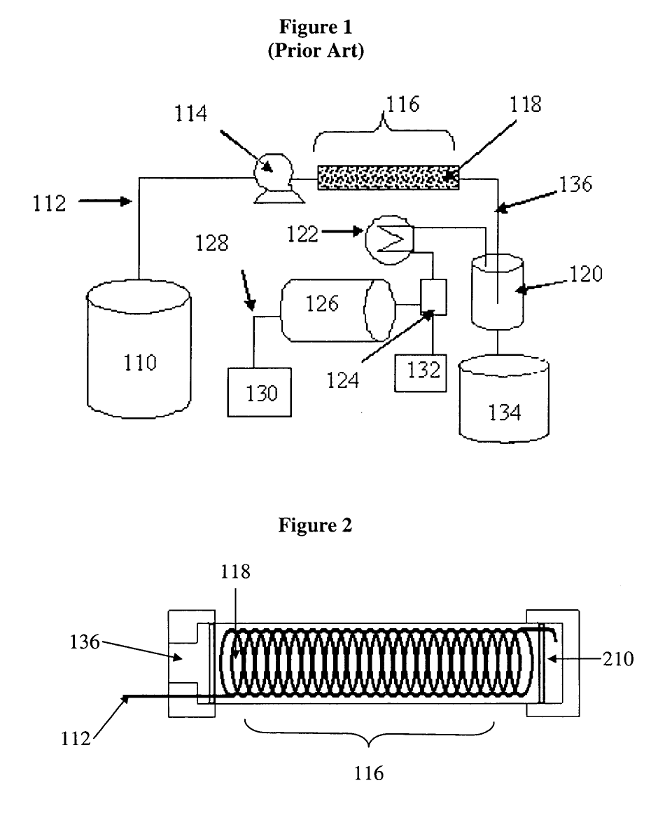

A schematic overview of a typical hydrogen generation system is provided in FIG. 1. The borohydride fuel solution is metered from storage tank 110 through fuel line 112 using fuel pump 114 and delivered into reactor 116 comprising catalyst bed 118 where it undergoes the reaction of Equation 1 to generate hydrogen and a borate salt. The product stream is carried to a gas liquid separator 120 via conduit line 136 and the hydrogen gas is processed through a heat exchanger 122 to cool the gas stream to near ambient temperature and a condenser 124 to remove water from the hydrogen gas stream. Condensed water is collected in water tank 132. The hydrogen gas is fed to a ballast tank 126 and then carried through the hydrogen conduit line 128 to feed a fuel cell 130. The liquid borate product stream from the gas-liquid separator 120 is drained to a borate tank 134.

The hydrogen ballast tank 126 for the system meets the instantaneous demand for hydrogen during initial startup of the hydrogen generation system. The size of this tank is dependent on the operating pressure and reactor throughput. Generally, lower operating pressures result in larger ballast tank volumes. Furthermore, large reactors which exhibit a low reactor throughput tend to require large ballast tanks. To avoid using a large tank, a portion of the residual hydrogen remaining in the reactor during the shutdown period can be released to environment. The improved reactor of the present invention enhances the hydrolysis reaction by increasing the reactor throughput by effective pressure, temperature, and water management, and reduces the balance of plant by eliminating or minimizing downstream features such as heat exchanger 122, ballast tank 126, gas/liquid separator 120, and condenser 124, and incorporating such functional elements within reactor 116.

The rate of hydrogen generation from sodium borohydride fuels is related to the reaction temperature which in turn depends on factors such as fuel concentration and flow rate, heat and mass transfer, and operating pressure. Typical reaction temperatures are between from about 100 to about 200° C. at an operating pressure between about 10 to about 200 psig with a fuel concentration of 20 wt % SBH and 3 wt % NaOH. The reactor can be operated in a self-sustainable fashion in which no heating of fuel or reactor is necessary for reactor startup and steady-state operation. When fuel is fed to the catalyst reactor at ambient temperature, there is a startup period necessary for the reactor to reach its normal steady-state operating temperature and the rate of hydrogen generation. This reactor startup time is a characteristic of the particular catalyst used and typically the more active, and more expensive, catalysts (such as ruthenium, platinum, and rhodium) have a reduced startup time. The startup time for the hydrogen generation system can be further reduced by providing a hydrogen ballast tank or pre-heated fuel to the reactor.

Rather than incorporating a separate heating element to heat the fuel in the hydrogen generator, the system efficiency can be improved by incorporating heat exchange elements that utilize the heat generated by the hydrolysis reaction itself. Previous attempts to capture the heat from the hydrolysis reaction by integrating a heat exchanger with the catalyst chamber as described in U.S. Patent Application Publication No. 2003/0091876, sought only to transfer the heat of the hydrolysis reaction to the fuel cell stack to bring the fuel cell unit to the optimum operating temperature, rather than using the heat to improve the reaction efficiency of the hydrolysis reaction.

In the integrated reactor of the present invention, the heat generated by the hydrogen generation reaction is transferred to the incoming fuel solution. As a result, the discharged fuel and hydrogen product streams are cooled as they exit the reaction chamber and further downstream heat exchange elements can be removed. The increase in temperature of the incoming fuel feed results in a higher reaction rate in the inlet section of reactor as compared to a cool fuel feed. The rate of reaction in the inlet section of the reactor affects overall reactor throughput; high reactor throughput significant reduces the overall size of the hydrogen generator systems and improves the control in cyclic or variable load operating conditions.

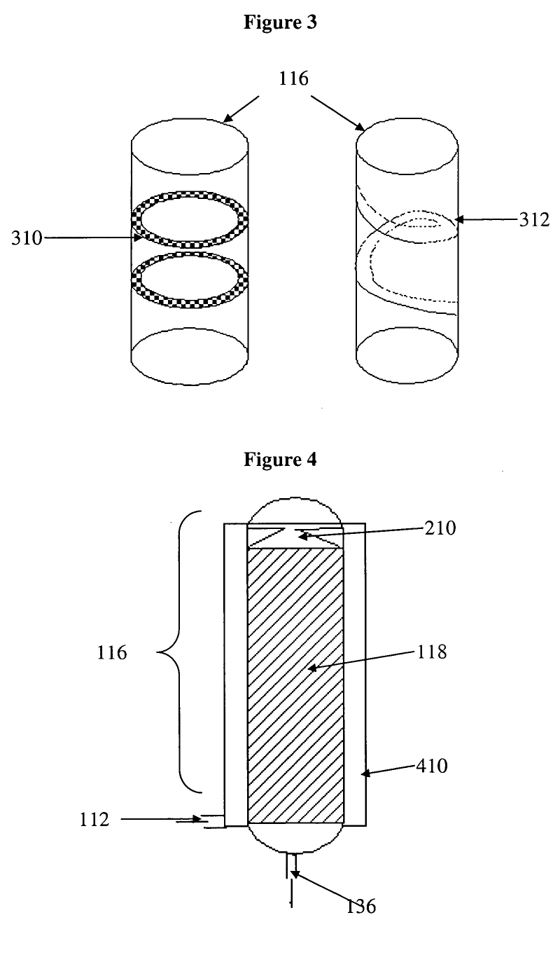

FIG. 2 illustrates a preferred configuration of a reactor 116 with a heat exchanging fuel line 112 surrounding or embedded in catalyst bed 118 and configured for countercurrent flow of fuel to allow heat exchange from the catalyst bed to the fuel. Prior to contact of the fuel with the catalyst bed, the fuel is preferably fed through a liquid distributor 210 to deliver a desired liquid flow pattern, minimize the improper distribution of fuel, and ensure desired flow dynamic conditions for high reactor throughput. By integrating the fuel line with the catalyst bed, the incoming fuel feed is heated to a temperature between about 30 to about 90° C., preferably between 50 and 70° C. To provide the delivery of desirable flow of fuel across the catalyst bed, such as for example, a substantially uniform flow across the surface area of the catalyst, distributor 210, while symbolically represented by two parallel lines in FIG. 2, can be implemented by a variety of structures. Such structures include, but not limited to, a plate with appropriately spaced and sized apertures or a funnel-shaped element that provides a substantially uniform flow of liquid across the catalyst bed. The fuel flow distribution through the reactor and the catalyst provided by distributor 210 can be further channeled through the use of one or more sieved rings 310 or a sieved ring belt 312 attached to the inner wall of the reactor 116 as liquid re-distributors as shown in FIG. 3. These liquid re-distributors minimize any channel leak along the reactor walls and provide the desired flow pattern necessary for high fuel conversion. The re-distributors of FIG. 3 can also be used in lieu of using distributor 210. The primary factors in the design of a liquid distributor/re-distributor is to ensure (1) the effective contact of liquid fuel with the catalytic material so as to provide good control of the hydrogen generation and (2) a flow pattern that minimizes “back-mixing” of fuel, i.e., the mixing of fuel after its contact with the catalytic material fuel with incoming fuel which dilutes the effective concentration. The combination of factors 1) and 2) maintains a consistent rate of hydrogen generation and helps minimize pressure drops across the catalyst bed. A liquid distributor/re-distributor that provides a uniform fuel flow has been found to be desirable.

For hydrogen generation systems of the present invention, the catalyst bed is preferably packed with a catalyst metal supported on a substrate. The preparation of such supported catalysts is taught, for example in U.S. Pat. No. 6,534,033 entitled “System for Hydrogen Generation,” the disclosure of which is incorporated herein by reference. Suitable transition metal catalysts for the generation of hydrogen from a metal hydride solution are known in the art and include metals from Group 1B to Group VIIIB of the Periodic Table, either utilized individually or in mixtures, or as compounds of these metals. Representative examples of these metals include, without intended limitation, transition metals represented by the copper group, zinc group, scandium group, titanium group, vanadium group, chromium group, manganese group, iron group, cobalt group and nickel group. Specific examples of useful catalyst metals include, without intended limitation, ruthenium, iron, cobalt, nickel, copper, manganese, rhodium, rhenium, platinum, palladium, and chromium. The catalyst may also be in forms of beads, rings, pellets or chips with a diameter ratio of reactor column to that of catalyst particle in a range of 8-100, preferably 10-50 and a ratio of packing height to column diameter in a range of 8-30, preferably 10-20 to ensure the desired flow pattern. It is preferred that structured catalyst supports such as honeycomb monoliths or metal foams are used in order to obtain the ideal plug flow pattern and mass transfer of the fuel to the catalyst surface. Such supports contain a plurality of liquid flow passages and will provide effective liquid fuel and catalyst contact and ensure desired fuel flow patterns as well as minimize the pressure drops across the catalyst bed.

The reactor can be orientated vertically or horizontally with various heat exchange configurations that allow efficient heat exchange between the reactor and the incoming fuel feed, including the use of a tube or coil in center of the reactor or a jacketed heat exchanger. FIG. 4 illustrates a reactor configuration where the fuel line 112 and fuel feed into a chamber 410 jacketing the catalyst bed 118 rather than surrounding the bed as a discrete fuel line coil as shown in FIG. 2. The fuel is passed through a liquid distributor 210 before contacting the catalyst bed to ensure the desired flow pattern.

FIG. 5 illustrates another reactor configuration comprising a central heat exchange element. The reactor 116 comprises two separate catalyst systems, 118a and 118b, surrounding a central fuel line 112. The incoming fuel passes through the line 112 to absorb heat from the reactor and is delivered to the catalyst bed 118 via a liquid distributor 210. To optimize the catalyst system and to reduce the total cost of catalyst, two different catalysts with different startup and performance characteristics are provided to customize the hydrogen production and startup response profile. A more active and/or more expensive catalyst, such as a supported ruthenium or platinum catalyst, is provided in the first portion of the reactor chamber as 118a. Such catalysts typically exhibit fast startup profiles and can generate hydrogen rapidly at lower temperatures, e.g., at temperatures ranging from about 25 to 50° C. A second catalyst bed, 118b, includes a cheaper catalyst metal such as nickel, cobalt, manganese, or zinc, that has a slow startup profile but has an acceptable hydrogen generation activity at higher temperatures, e.g., at temperatures from about 50 to 90° C., so that once the fuel and reactor reach the normal operating temperature, hydrogen generation is consistent and sustainable. The combination of two catalysts in a single reactor will take advantages of benefits of fast startup of a highly active catalyst and satisfactory “steady-state” activity of a cheaper catalyst.

The operating pressure is one of the most important considerations in the design of borohydride based hydrogen storage system and the pressure directly affects the operating temperature of the reactor. The amount of liquid water present in a catalyst reactor relative to water vapor increases at higher operating pressures. In addition, the pressure significantly affects the contact time between the liquid fuel and the catalyst system. Inside the catalyst bed, the amount of generated hydrogen and water vapor formed in reactor takes up considerable reactor volume that reduces the contact time of liquid fuel to catalyst. For example, if the reactor operates at 10 psig, the contact time between the liquid fuel and catalyst is only about 10% of that at 180 psig. It is beneficial to operate the reactor at relatively high pressures to increase the liquid fuel contacting time.

Since sodium borohydride hydrolysis is an exothermic reaction, the reactor can be operated in a self-sustainable fashion without requiring external heating of the reactor or fuel for reactor startup and operation. A typical reaction temperature of about 150° C. is reached at an operating pressure of 55 psig for complete conversion of an aqueous fuel containing 20 wt-% NaBH₄ and 3 wt-% NaOH. For a high reactor throughput, the reactor is preferably operated at pressures between 10 and 250 psig, preferably between 20 and 220 psig, and most preferably between 50 to 180 psig.

Simultaneous removal of hydrogen in the reactor further improves the contact between the liquid fuel and solid catalyst, thus significantly increasing the reactor throughput. For example, if the overall rate is controlled by reaction kinetics, removal of 95% of the hydrogen produced from a reactor using a 20 wt-% sodium borohydride fuel could increase the reactor throughput more than 20 fold compared to a reactor operated without hydrogen removal. It is necessary that the membrane operate under elevated pressure and temperatures (up to 240° C.) and be hydrophobic to acts as a condenser and filter to prevent any entrained impurities and water from crossing into the hydrogen gas delivered to the fuel cell. Suitable materials include commercially available polytetrafluoroethylene (PTFE) membranes. The “dual use” membrane also contributes to the reduction of the balance of plant by eliminating downstream condenser 124 and gas/liquid separator 120. The membrane can be designed to withstand operating system pressures by judicious choice of material thickness. The pressure tolerance of a given membrane can also be strengthened by sandwiching it between sieved metal sheets/plates. Accordingly, PTFE membranes operably at pressures up to 200 psig are possible and the need for operating above these pressures is presently not considered desirable for safety and economic reasons. The operating temperature of a system is proportional to system pressure, and the preferred upper temperature limit is 220 C. Above this temperature, the cost of process elements operable at the such temperatures and associated pressures are prohibitive for most present system applications.

Accordingly, the present invention contemplates catalytic reactors for the hydrolysis of a fuel, such as metal borohydrides, having one or more of the exemplified elements—a) a heat exchanging mechanism for pre-heating the fuel prior to its contact with the catalyst, b) liquid distributors/re-distributors for providing fuel distribution over the catalyst that enhances the hydrogen generating capabilities resulting from the interaction of the fuel and catalyst, c) membrane which separate the hydrogen generated from the fuel and which are capable of operating at pressures greater than 50 psig and d) multiple catalytic materials having different hydrogen generating characteristics.

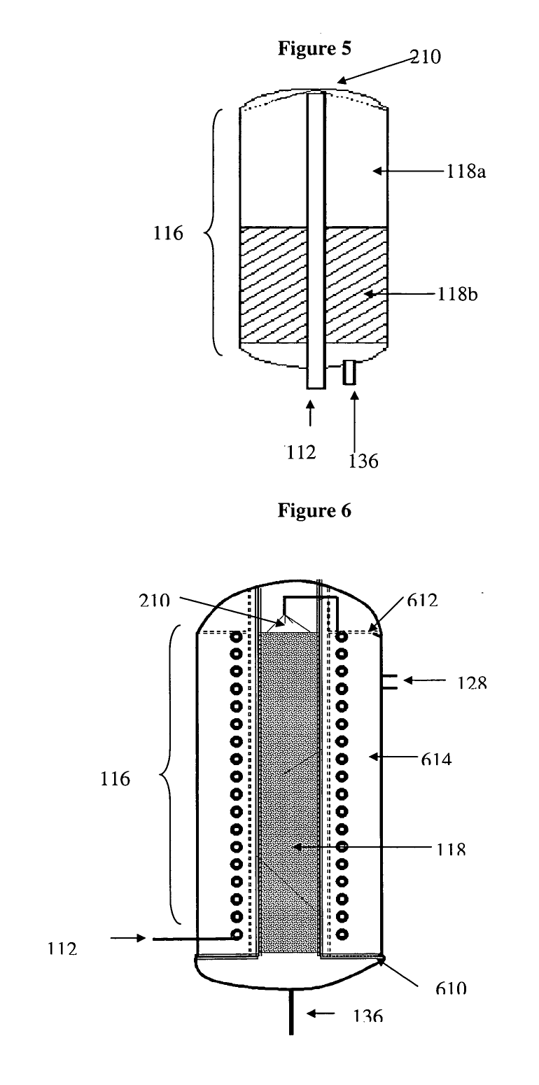

A reactor design to provide effective fuel/catalyst contact incorporating all elements described to improve reactor throughput and provide a controlled fuel flow pattern to maximize fuel conversion and reactor throughput is presented in FIG. 6. The reactor 116 comprises an outer housing and an internal catalyst bed 118 surrounded by a membrane 610. The catalyst bed is held in place by sieve plate 612. The fuel line 112 surrounds the catalyst bed and acts as a heat exchanger. Fuel is delivered from the fuel line into liquid distributor 210 before contacting the catalyst bed. Hydrogen is produced on contact of the fuel with the catalyst bed, and hydrogen is separated from the borate product stream by membrane 610. Hydrogen passes into the space between the heat exchanger and the outer wall, the hydrogen ballast chamber 614, and is fed to the fuel cell via conduit 128. The ballast chamber supplies hydrogen to the fuel cell during reactor startup and stores hydrogen during the reactor shutdown. The borate stream exits reactor 116 via conduit 136.

While FIG. 6 illustrates a fuel line/heat exchange combination coiled around a membrane covered catalyst bed, the heat exchanger can be embedded inside the catalyst bed to maximize the heat exchange efficiency, or the catalyst bed can be surrounded by the heat exchanger and both units then surrounded with an outer membrane layer, or the heat exchanger can surround the outer membrane layer.

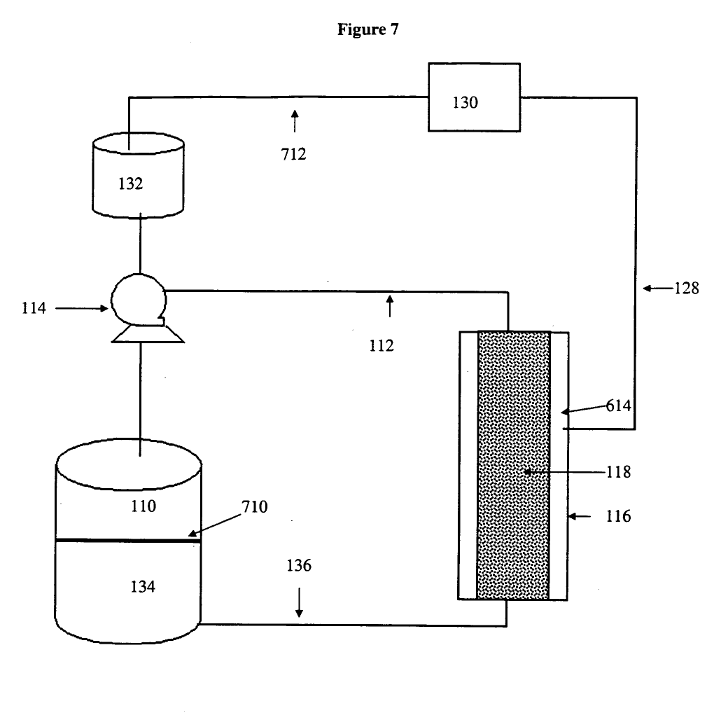

A schematic overview of a hydrogen generation system incorporating the integrated reactor design of the present invention and utilizing fuel cell water recycle is provided in FIG. 7. It is desirable to use the highest possible fuel concentrations to maximize hydrogen storage density within the system. Where the concentration of the metal hydride in the fuel exceeds the maximum solubility of the particular salt utilized, the fuel will be in the form of a slurry or suspension. This is acceptable provided that only a minor portion of the chemical hydride is not in solution and the fuel system includes a means of maintaining the uniformity of the slurry or suspension withdrawn and providing a means to dilute the concentrate before exposure to the catalyst. It has been proposed to add excess water from a separate source during the reaction, such as the water produced by the hydrogen-consuming device, e.g. a fuel cell, combustion engine or the like, as in U.S. Pat. No. 6,534,033.

The borohydride fuel is metered from a storage tank 110 through a fuel concentrate conduit line 112 using a fuel pump 114. The fuel can be diluted with water from a water tank 132 to dilute the incoming fuel to a desired borohydride concentration. FIG. 7 shows water recycled from the fuel cell 130 to feed the water storage tank; in practice, this water can simply be a refillable water tank. The fuel is delivered into the integrated reactor 116 where it undergoes the reaction of Equation 1 to generate hydrogen and a borate salt. The hydrogen is separated from the borate salt solution by the membrane surrounding the catalyst bed 118. The hydrogen gas passes through the membrane into the ballast chamber 614 and is withdrawn from the reactor through the hydrogen conduit line 128 to feed a fuel cell. The borate product stream is withdrawn from the reactor via conduit line 136 and transported to borate storage tank 134. For maximum system storage density, the fuel storage tank 110 and the borate storage tank 134 are configured in a volume exchange tank, separated by a moveable partition 710. Partition 710 provides effective insulation to minimize heat transfer between the borate product and the fuel solution to avoid the undesired fuel decomposition.

The following examples further describe and demonstrate features of the improved reactor throughput according to the present invention. The examples are given solely for the illustration purposes and are not to be construed as a limitation of the present invention.

### EXAMPLE 1

A tubular reactor having a 1.0″ outside diameter (“o.d.”) and a length of 7″ (volume of 60 mL) was used for reactor performance tests. The supported catalyst systems were prepared as described in U.S. Pat. No. 6,534,033. Two catalyst systems were tested: ruthenium-cobalt on nickel metal fiber (RuCo/Ni) with a nominal loading of 1.2 wt-% Ru and 3 wt-% Co and cobalt-zinc on nickel metal fiber (CoZn/Ni) with a nominal loading of 3 wt-% Co and 3 wt-% Zn.

Reactor A was packed with 55 g of RuCo/Ni catalyst; Reactor B was packed with 55 g of CoZn/Ni catalyst. Reactor C was packed with two catalyst beds in accordance with FIG. 5 but Without a heat exchange element; 25 g of RuCo/Ni catalyst was placed in the first portion of the reactor 116 (catalyst bed 118a) and 25 g of CoZn/Ni catalyst was placed in the second portion of the reactor 116 (catalyst bed 118b). Reactors were operated horizontally without insulation and without integration of heat exchanger and membrane elements using an aqueous fuel of 20 wt-% NaBH₄ and 3 wt-% NaOH.

The reactor startup time was measured at 55 psig and a feed fuel temperature of 22° C. under a constant fuel flow of 20 g/min. Steady-state performance of the reactor is assessed by measuring reactor throughput at a fuel conversion greater than 98% under a self-sustainable operation at 55 psig. The reactor throughput is defined as amount of hydrogen generated per unit time and per unit reactor volume.

Although Reactor B packed with a CoZn/Ni catalyst had a slow startup of 1250 s and an achievable reactor throughput of 332 standard liters per minute (SLPM) H₂ per liter of reactor volume, Reactor C packed with two catalysts (RuCo/Ni—CoZn/Ni) had a startup time of 260 s and high reactor throughput close to that exhibited by Reactor A packed with only RuCo/Ni catalyst (Table 1).

TABLE 1

| | | Startup | Reactor throughput (SLPM H₂ |
|---|---|---|---|
| Reactor | Catalyst | time(s) | per liter of reactor volume) (a) |
| A | RuCo/Ni | 180 | 750 |
| B | CoZn/Ni | 1250 | 332 |
| C | RuCo/Ni—CoZn/Ni | 260 | 697 |

(a) Throughput necessary for >98% fuel conversion and self-sustainable hydrogen generation.

Reactor A was further integrated with a heat exchange coil as illustrated in FIG. 2. The reactor volume for catalyst packing is 45.2 mL with 33.1 g catalyst. Reactor was operated at 55 psig with an aqueous fuel of 20 wt-% sodium borohydride and 3 wt-% NaOH. The reactor integrated with heat-exchange coils shows a startup time of about 180 s at a constant fuel flow rate of 20 g/min. Significant improvements in reactor throughput were achieved at various fuel conversion levels, particularly at 99% where over two fold increase in reactor throughput was achieved (Table 2). Furthermore, constant reaction temperature profiles can be maintaned over a wide range of fuel flow rates that offers a wide operating window for system response to hydrogen demend.

TABLE 2

| | Ratio of reactor throughput with heat exchanger to |
|---|---|
| Fuel conversion, % | that without heat exchanger |
| 99 | 2.8 |
| 95 | 1.9 |
| 90 | 1.4 |
| 80 | 1.3 |
| 65 | 1.8 |

While the present invention has been described with respect to particular disclosed embodiments, it should be understood that numerous other embodiments are within the scope of the present invention. First, for example, the present invention may be used in a catalytic reactor which operates with a fuel other than sodium borohydride. Second, while particular heat exchanger configurations have been disclosed, the present invention is applicable to numerous structures known in the art that are disposed so as to receive the transfer the heat from the hydrogen generation process to the incoming fuel solution. Similarly, various liquid diffusing elements known in the art, other than those shown, can be utilized to provide the desired distribution of the fuel across the surface of the catalyst(s). Finally, while the use of two catalysts in the reactor has been disclosed, the reactor may utilize more than two such materials.

1. A catalytic reactor for use in a hydrogen generation system, said reactor comprising an inlet for receiving a fuel solution and a first catalytic material that generates hydrogen upon contact with said fuel solution via an exothermic reaction, said reactor further comprising at least one element selected from the group of elements consisting of:
a) a heat exchanging element that transfers heat from the exothermic reaction to preheat said fuel solution prior to its contact with said first catalytic material,
b) a liquid diffusing element which distributes the flow of said fuel solution to enhance its contact with said first catalytic material,
c) a second catalytic material that generates hydrogen upon contact with said fuel solution, said second catalytic material being disposed in said catalytic reactor to contact said fuel solution, said second catalytic material having hydrogen generation characteristics that are different from those of said first catalytic material, and
d) a membrane operative at pressures of at least 50 psig that separates the hydrogen from said fuel solution.

2. The reactor of claim 1 including said heat exchanging element and wherein this element surrounds said first catalytic material.

3. The reactor of claim 1 including said heat exchanging element and wherein this element is surrounded by said first catalytic material.

4. The reactor of claim 1 including said liquid diffusing element and wherein said element includes a sieved ring.

5. The reactor of claim 1 including said membrane and said membrane is hydrophobic and surrounds said first catalytic material.

6. The reactor of claim 5 wherein said membrane is polytetrafluoroetheylene.

7. The reactor of claim 5 including a ballast chamber for receiving and storing the hydrogen gas separated by said membrane.

8. The reactor of claim 1 wherein said first catalytic material comprises a transition metal selected from the group consisting of ruthenium, iron, cobalt, nickel, copper, manganese, rhodium, rhenium, platinum, palladium, chromium, silver, osmium, iridium, borides thereof, alloys thereof, and mixtures thereof.

9. The reactor of claim 8 wherein said first catalytic material is disposed in a supporting structure.

10. The reactor of claim 9 wherein said support structure is a honeycomb monolith.

11. The reactor of claim 9 wherein said support structure is a metal foam.

12. The reactor of claim 1 including said membrane, wherein said membrane also surrounds said second catalytic material.

13. A hydrogen gas generation system, said system comprising:
(a) a fuel storage chamber containing an aqueous solution of at least one chemical hydride,
(b) a catalytic reactor, said reactor comprising an inlet for receiving said aqueous solution and a first catalytic material that generates hydrogen upon contact with said solution via an exothermic reaction, said reactor further comprising at least one element selected from the group of elements consisting of:
i) a heat exchanging element that transfers heat from the exothermic reaction to preheat said incoming aqueous solution prior to its contact with said first catalytic material,
ii) a liquid diffusing element which distributes the flow of said aqueous solution to enhance its contact with said first catalytic material,
iii) a second catalytic material that generates hydrogen upon contact with said aqueous solution, said second catalytic material being disposed in said catalytic reactor to contact said aqueous solution and said first and second catalytic materials having different hydrogen generation characteristics, and
iv) a membrane operative at pressures of at least 50 psig that separates the hydrogen generated from the contact of said aqueous solution with said first catalytic material, and
(c) a conduit for conveying the aqueous solution from the fuel storage chamber to the reactor and
(d) an outlet conduit to convey a liquid byproduct of the exothermic reaction to a storage chamber.

14. A method of generating hydrogen from a fuel solution using a catalytic reactor having a first catalytic material that generates hydrogen upon contact with said fuel solution via an exothermic reaction, said reactor further comprising at least one element selected from the group of elements consisting of:
a) a heat exchanging element that transfers heat from the exothermic reaction to preheat said incoming fuel solution prior to its contact with said first catalytic material,
b) a liquid diffusing element which distributes the flow of said fuel solution to enhance its contact with said first catalytic material,
c) a second catalytic material that generates hydrogen upon contact with said fuel solution, said second catalytic material being disposed in said catalytic reactor to contact said fuel solution and said first and second catalytic materials having different hydrogen generation characteristics, and
d) a membrane capable of withstanding pressures of at least 50 psig and operative at said pressures to separate the hydrogen generated from the contact of said fuel solution with said first catalytic material.
